(19) United States
(12) Patent Application Publication
(10) Pub. No.: US 2005/0041003 A1
(43) Pub. Date: Feb. 24, 2005

(54) Electro-optical device, driving method thereof, and electronic apparatus

(75) Inventor: Tadashi Yamada, Shiojiri-city (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/353,933

(22) Filed: Jan. 30, 2003

(30) Foreign Application Priority Data
Feb. 1, 2002 (JP) 2002-026130
Jan. 30, 2003 (JP) 2003-022024

(51) Int. Cl. G09G 3/30; G09G 3/28; G09G 3/34

(52) U.S. Cl. 345/77; 345/63; 345/84

(57) ABSTRACT

An electrooptical apparatus includes a plurality of scanning lines, a plurality of signal lines, and electrooptical devices, each being placed at an intersection of each of the scanning lines and each of the signal lines. The electrooptical apparatus is driven according to the amount of drive current supplied to the electrooptical devices. The electrooptical apparatus includes a brightness detection unit to detect the brightness of the electrooptical devices, and a drive current amount adjusting unit to adjust the amount of drive current based on the detected brightness result obtained by the brightness detection unit in order to correct for the brightness of the electrooptical devices.

An electrooptical apparatus having a plurality of scanning lines, a plurality of signal lines, and an electrooptical device placed at an intersection of each of the scanning lines and each of the signal lines, said electrooptical apparatus being driven according to the amount of drive current supplied to the electrooptical devices, said electrooptical apparatus comprising:
a brightness detection unit for detecting the brightness of the electrooptical devices; and
a drive current amount adjusting unit for adjusting the amount of drive current based on the detected brightness result obtained by said brightness detection unit.

An electrooptical apparatus having a plurality of scanning lines, a plurality of signal lines, and an electrooptical device placed at an intersection of each of the scanning lines and each of the signal lines, said electrooptical apparatus comprising:
a driver which includes a D/A converter for converting digital data into analog data and which supplies the analog data to the electrooptical devices;
a brightness detection unit for detecting the brightness of the electrooptical devices; and
a reference voltage adjusting unit for adjusting a reference voltage for the D/A converter based on the detected brightness result obtained by said brightness detection unit.

An electrooptical apparatus having a plurality of scanning lines, a plurality of signal lines, and an electrooptical device placed at an intersection of each of the scanning lines and each of the signal lines, said electrooptical apparatus comprising:
a driver for supplying luminance data to the electrooptical devices;
a control circuit for supplying to said driver digital data which is a reference for the luminance data;
a brightness detection unit for detecting the brightness of the electrooptical devices; and
a data correction circuit for correcting the digital data based on the detected brightness result obtained by said brightness detection unit.

An electrooptical apparatus according to any one of claims 1 to 3, wherein the electrooptical devices include three types of electrooptical devices for R (red), G (green), and B (blue), and
said brightness detection unit detects the brightness for each of the three types of electrooptical devices.

An electrooptical apparatus according to any one of claims 1 to 3, wherein the electrooptical devices include three types of electrooptical devices for R (red), G (green), and B (blue);
the three types of electrooptical devices illuminate R (red), G (green), and B (blue) light by passing light emitted from a common light source for the three types of electrooptical devices through a color conversion unit provided for each of the three types of electrooptical devices; and
said brightness detection unit detects the brightness of the common light source as the brightness of the electrooptical devices.

An electrooptical apparatus according to claim 1, wherein the electrooptical devices include three types of electrooptical devices for R (red), G (green), and B (blue);
the three types of electrooptical devices illuminate R (red), G (green), and B (blue) light by passing light emitted from a common light source for the three types of electrooptical devices through a color conversion unit provided for each of the three types of electrooptical devices; and
said brightness detection unit detects the light passing through at least one of the color conversion units of the three types of electrooptical devices for the brightness of the electrooptical devices.

An electrooptical apparatus according to any one of claims 1 to 6, further comprising a brightness detectability determination unit for determining whether or not the brightness detection by said brightness detection unit is possible.

An electrooptical apparatus according to any one of claims 1 to 5, wherein it is determined whether or not the brightness detection by said brightness detection unit is possible based on the brightness of the electrooptical devices detected by said brightness detection unit.

An electronic device comprising the electrooptical apparatus according to any one of claims 1 to 8.

A driving method of an electrooptical apparatus having a plurality of scanning lines, a plurality of signal lines, and an electrooptical device placed at an intersection of each of the scanning lines and each of the signal lines, said driving method comprising:
a first step of detecting the brightness of the electrooptical devices; and
a second step of adjusting the amount of drive current based on the detected brightness result.

A driving method of an electrooptical apparatus having a plurality of scanning lines, a plurality of signal lines, an electrooptical device placed at an intersection of each of the scanning lines and each of the signal lines, and a driver which includes a D/A converter for converting digital data into analog data and which supplies the analog data to the electrooptical devices, said driving method comprising:
a first step of detecting the brightness of the electrooptical devices; and
a second step of defining a reference voltage for the D/A converter based on the detection result obtained in said first step.

A driving method of an electrooptical apparatus having a plurality of scanning lines, a plurality of signal lines, and an electrooptical device placed at an intersection of each of the scanning lines and each of the signal lines, brightness data being supplied to the electrooptical devices via a driver, said driving method comprising:
a first step of detecting the brightness of the electrooptical devices; and
a second step of correcting the digital data based on the detection result obtained in said first step.

A driving method according to claim 11 or 12, wherein, in said first step, the brightness is detected for each of three colors, R, G, and B,(red, green, and blue).

A driving method according to any one of claims 10 to 13, wherein, prior to said first step, it is determined in advance whether or not the brightness detection is possible.

A driving method according to claim 10 or 14, wherein it is determined whether or not the brightness detection by the brightness detection unit is possible based on the detected brightness of the electrooptical devices.

### DETAILED DESCRIPTION OF THE INVENTION

### TECHNICAL FIELD OF THE INVENTION

The present invention relates to an electrooptical apparatus, a driving method thereof, and an electronic device.

### DESCRIPTION OF THE RELATED ART

For example, in the art of organic EL (electroluminescent) display apparatuses, the degradation of the luminous brightness of organic EL devices of the organic EL display apparatuses over time is much more rapid than that of inorganic EL display apparatuses. That is, as the lighting time accumulates, the reduction in brightness becomes noticeable. Specifically, the life of the inorganic EL display apparatuses is over 100,000 hours, during which the reduction in brightness is hardly exhibited. In contrast, in the organic EL display apparatuses, the lighting time with a luminance of, for example, 300 cd/m² is up to approximately 10,000 hours.

Accordingly, this drawback can be overcome by improving the manufacturing process (see Patent Documents 1 and 2).
[Patent Document 1] Japanese Unexamined Patent Application Publication No. 11-154596
[Patent Document 2] Japanese Unexamined Patent Application Publication No. 11-214257

### PROBLEMS TO BE SOLVED BY THE INVENTION

In reality, however, with the approach of improving the manufacturing process, it is difficult to completely prevent the reduction in brightness. The present invention is intended to overcome this problem, and an object of the present invention is to provide a technique for compensating for a change in brightness over time by means of an approach involving circuit technology.

[Means for Solving the Problems]

According to the present invention, there is provided a first electrooptical apparatus having a plurality of scanning lines, a plurality of signal lines, and an electrooptical device placed at an intersection of each of the scanning lines and each of the signal lines, the electrooptical apparatus being driven according to the amount of drive current supplied to the electrooptical devices. The electrooptical apparatus includes a brightness detection unit for detecting the brightness of the electrooptical devices; and a drive current amount adjusting unit for adjusting the amount of drive current based on the detected brightness result obtained by the brightness detection unit in order to correct for the brightness of the electrooptical devices.

It is to be noted that the amount of drive current is defined according to the value of the drive current and the length of a period in which the drive current is supplied to the electrooptical apparatus.

According to the present invention, there is provided a second electrooptical apparatus having a plurality of scanning lines, a plurality of signal lines, and an electrooptical device placed at an intersection of each of the scanning lines and each of the signal lines. The electrooptical apparatus includes a driver which includes a D/A converter for converting digital data into analog data and which supplies the analog data to the electrooptical devices; a brightness detection unit for detecting the brightness of the electrooptical devices; and a reference voltage adjusting unit for adjusting a reference voltage for the D/A converter based on the detection brightness result obtained by the brightness detection unit.

According to the present invention, there is provided a third electrooptical apparatus having a plurality of scanning lines, a plurality of signal lines, and an electrooptical device placed at an intersection of each of the scanning lines and each of the signal lines. The electrooptical apparatus includes a driver for supplying brightness data to the electrooptical devices; a control circuit for supplying to the driver digital data which is a reference for the brightness data; a brightness detection unit for detecting the brightness of the electrooptical devices; and a data correction circuit for correcting the digital data based on the detected brightness result obtained by the brightness detection unit.

Typically, an electrooptical apparatus such as a liquid crystal apparatus or an electroluminescent apparatus often includes three types of electrooptical devices for R (red), G (green), and B (blue). In such an electrooptical apparatus, the above-noted electrooptical devices may include three types of electrooptical devices for R (red), G (green), and B (blue); the brightness detection unit may detect the brightness for each of,the three types of electrooptical devices; and the drive current amount adjusting unit may adjust the amount of drive current based on the detected brightness for each type.

In a case where the three types of electrooptical devices illuminate R (red), G (green), and B (blue) light by passing light emitted from a common light source for the three types of electrooptical devices through a color conversion unit provided for each of the three types of electrooptical devices, the brightness detection unit may detect the brightness of the common light source for the brightness of the electrooptical devices. Alternatively, the brightness detection unit may detect the light passing through at least one of the color conversion units of the three types of electrooptical devices as the brightness of the electrooptical devices.

Preferably, the electrooptical apparatus further includes a brightness detectability determination unit for determining whether or not the brightness detection by the brightness detection unit is possible.

It may also be determined whether or not the brightness detection performed by the brightness detection unit is possible based on the brightness of the electrooptical devices detected by the brightness detection unit.

An electronic device according to the present invention includes the above-noted electrooptical apparatus.

According to the present invention, there is provided a first driving method of an electrooptical apparatus having a plurality of scanning lines, a plurality of signal lines, and an electrooptical device placed at an intersection of each of the scanning lines and each of the signal lines, the electrooptical apparatus being driven according to the amount of drive current supplied to the electrooptical devices. The driving method includes a first step of detecting the brightness of the electrooptical devices, and a second step of adjusting the amount of drive current based on the detection result obtained in the first step.

According to the present invention, there is provided a second driving method of an electrooptical apparatus having a plurality of scanning lines, a plurality of signal lines, an electrooptical device placed at an intersection of each of the scanning lines and each of the signal lines, and a driver which includes a D/A converter for converting digital data into analog data and which supplies the analog data to the electrooptical devices. The driving method includes a first step of detecting the brightness of the electrooptical. devices, and a second step of defining a reference voltage for the D/A converter based on the detection result obtained in the first step.

According to the present invention, there is provided a third driving method of an electrooptical apparatus having a plurality of scanning lines, a plurality of signal lines, and an electrooptical device placed at an intersection of each of the scanning lines and each of the signal lines, brightness data being supplied to the electrooptical devices via a driver. The driving method includes a first step of detecting the brightness of the electrooptical devices, and a second step of correcting the digital data based on the detection result obtained in the first step.

In the above-noted driving method, in the first step, preferably, the brightness is detected for each of three colors, R (red), G (green), and B (blue).

Prior to the first step, it may be determined in advance whether or not the brightness detection is possible.

It may also be determined whether or not the brightness detection by the brightness detection unit is possible based on the detected brightness of the electrooptical devices.

In the present invention, pixel colors are not limited to three colors, R, G, and B (red, green, and blue), and any other color may be used.

Other features of the present invention will become apparent from the accompanying drawings and the following description.

### DESCRIPTION OF THE EMBODIMENTS

An embodiment of the present invention is described below. In this embodiment, an electrooptical apparatus implemented as a display apparatus (hereinafter referred to as an organic EL display apparatus) which employs organic electroluminescent devices (hereinafter referred to as organic EL devices), and a driving method thereof are described, by way of example.

First, the organic EL display apparatus is briefly described. As is well known in the art, an organic EL panel constituting the organic EL display apparatus is formed of a matrix of unit pixels including organic EL devices. The circuit structure and operation of the unit pixels are such that, for example, as described in a book titled “ELECTRONIC DISPLAYS” (Shoichi Matsumoto, published by Ohmsha on Jun. 20, 1996) (mostly, page 137), a drive current is supplied to each of the unit pixels to write a predetermined voltage to an analog memory formed of two transistors and a capacitor so as to control lighting (illumination) of the organic EL devices.

In the embodiments according to the present invention, the brightness of the display panel of the organic EL display apparatus is detected by a brightness sensor for brightness correction based on the detection result.

First Embodiment

As shown in FIG. 1(a), an organic EL display apparatus according to the first embodiment includes a brightness sensor 10 formed of a photodiode or a CCD device, a C-MOS device, and so on, an ADC (analog-to-digital converting circuit) 20, an organic EL panel control circuit 30, a DAC (digital-to-analog converter) 40, a driver 50 including a current generating circuit for generating a data current corresponding to digital data, and an organic EL panel 60. As shown in FIG. 1(b), the organic EL panel control circuit 30 includes a comparator 30a, a brightness table 30b, an output voltage table 30c, and a selector 30d.

The brightness sensor 10 has means for determining whether or not light is shielded so as not to detect external light other than the light of the organic EL panel 60. This light shielding unit is described below in conjunction with application examples. The organic EL panel control circuit 30 can be configured by hardware using a circuit for achieving functions, or by software using a microcomputer to achieve the functions.

As discussed above, the organic EL panel 60 may be formed of a plurality of organic EL devices having light-emitting layers for R (red), G (green), and B (blue) light, or may be formed of a plurality of organic EL devices having color conversion layers for R (red), G (green), and B (blue) for converting light emitted from a common white light source into R (red), G (green), and B (blue) light.

First, the overall operation is described. Light emitted from the organic EL panel 60 is detected by the brightness sensor 10, and a voltage Eout indicating the detection result is output to the ADC 20. The voltage Eout is converted by the ADC 20 into a digital signal, which is then output to the organic EL panel control circuit 30. The comparator 30a which receives the digital signal refers to the predetermined brightness table 30b stored in a non-volatile memory or the like to determine whether or not the detected brightness is the predetermined brightness. The brightness data of the brightness table 30b to be compared with the detection,result Eout may be selected in accordance with given digital data h.

The comparison result is output to the selector 30d. As described in detail below, the selector 30d which receives the comparison result outputs an instruction value to the DAC 40 so that an appropriate reference voltage Vref is output from the output voltage table 30c based on the comparison result. In response to the instruction value, the DAC 40 outputs the corrected reference voltage Vref, as described in detail below, to a DAC included in the driver 50. The reference voltage Vref is a reference voltage based on which the digital data h is converted by the DAC of the driver 50 into an analog value. In this way, analog data to be supplied to the organic EL panel 60 is corrected based on the detection result.

A specific technique of brightness correction is described below. As depicted in the flowchart of FIG. 2 showing an adjustment sequence, in order to accurately measure the brightness, it is determined whether or not light is shielded (S10). When light is shielded, adjustment (in this figure, calibration) starts (S10: YES, then the process proceeds to S20). Then, with reference to the above-described output voltage table 30b shown in FIG. 1(b), the reference voltage Vref is determined for each color of R (Red), G (Green), and B (Blue) (S30 through S80).

When the organic EL panel 60 is formed of a plurality of organic EL devices having color conversion layers for R (red), G (green), and B (blue) for converting light emitted from a common white light source into R (red), G (green), and B (blue) light, the brightness of the common white light source may be detected, or the brightness of at least one of the R (red), G (green), and B (blue) light may be detected.

Second Embodiment

In the second embodiment, the brightness is measured without the output voltage table used in the first embodiment, and is adjusted until the reference voltage Vref is corrected to achieve a target brightness. Thus, the structure of the overall apparatus of the second embodiment is similar to that shown in FIG. 1(a), but the organic EL panel control circuit 30 is formed of a programmable microcomputer or the like for executing an adjustment sequence shown in FIG. 3 in place of the structure shown in FIG. 1(b). This allows the reduction in circuit dimension compared to the first embodiment. The other components are common to those described above in the first embodiment, and the difference therebetween is primarily described below.

Specifically, as shown in FIG. 3, it is determined whether or not light is shielded (S10), and adjustment (in the figure, calibration) starts when the light is shielded (S20). Then, reference voltages Vref for R (Red), G (Green), and B (Blue) are determined in turn (S10 through S120). As depicted in a characteristic graph of the output voltage Eout of the brightness sensor with respect to an image data value shown in FIG. 6, the ideal relation between both is defined for the respective colors as target adjustment ranges centered by target values (EGtgt, EBtgt, and ERtgt). In order to achieve the ideal correspondence, appropriate adjustment step voltages (Rstep, Gstep, and Bstep) are provided for the respective colors to correct the reference voltages VrefR, VrefG, and VrefB for the respective colors.

First, correction for the brightness of red (Red) light is described, by way of example. As depicted in FIG. 3, when the output voltage ER (Eout) of the brightness sensor is within the target adjustment range shown in FIG. 4 (S50: YES), the brightness of other color light is corrected; or, otherwise (S50: NO), the reference voltage VrefR is adjusted (S60). The target adjustment range is a range from 0.9 times to 1.1 times the target value ERtgt of the output voltage ER of the brightness sensor. If the output voltage ER does not reach this range, the adjustment step voltage Rstep is added to the reference voltage VrefR to increase the reference voltage Vref, thereby performing control so as to bring the reduced brightness into close proximity to the target value. If the output voltage ER exceeds this range, reversely, the adjustment step voltage Rstep is subtracted from the reference voltage VrefR to decrease the reference voltage Vref, thereby performing control so as to bring too high brightness into close proximity to the target value. Subsequently, as depicted in FIG. 3, similar control is performed for each color of green and blue (S70 through S120).

The above-described series of process steps can be expressed in the manner shown in, for example, FIG. 5. Specifically, the detected brightness result Eout of the organic EL panel is converted by the ADC 20 into a digital value, which is then compared to an initial value (for example, digital data indicating the detection result Eout at the shipment time), and the digital data is corrected so as to achieve the target value according to the comparison result. The corrected digital data is converted by the DAC 40 into an analog value, and the analog value is set as the reference voltage Vref for a DAC included in the driver 50.

The period in which the above-described series of process steps are performed is set, as required, resulting in dynamic brightness correction during continuous use.

In the above-described example, the reference voltage Vref of the DAC of the driver 50 is adjusted based on the detected brightness result. Alternatively, a drive voltage or the data itself can be adjusted or modified according to the detection result.

As an example, as depicted in FIG. 6, the detection result Eout is converted by the ADC 20 into a digital signal, which is then input to the comparator 30a in the organic EL panel control circuit, and the comparator 30a refers to the predetermined brightness table 30b stored in a non-volatile memory or the like to determine whether or not the detected brightness is more appropriate than the uncorrected brightness. This comparison result is output to the selector 30d.

For detection, preferably, the brightness is detected when a predetermined digital signal is input, and data (that is, initial data) corresponding to the detection result is stored in the brightness table 30b to be compared.

The selector 30d which receives the comparison result selects appropriate data from the data of a drive voltage table 30e, and outputs it to a DAC included in a power supply circuit 70. The output of this DAC defines a drive voltage Voel to be supplied to the organic EL panel.

As another example, as shown in FIG. 7, the digital data itself may be modified according to the detection result Eout. In this case, the detection result Eout is converted by the ADC 20 into a digital signal, which is then input to the comparator 30a in the organic EL panel control circuit, and the comparator 30a refers to the predetermined brightness table 30b stored in a non-volatile memory or the like to determine whether or not the uncorrected brightness is the desired brightness. This comparison result is output to the selector 30d, and appropriate data is selected from an output data table based on this output to set a reference value for correction performed by a data correction circuit 80. Digital data m corrected by the data correction circuit 80 is input to a DAC included in the driver 50, and is then converted into analog data iout, and the analog data iout is supplied to the organic EL panel.

The examples shown in FIGS. 6 and 7 are also applicable to dynamic brightness correction shown in FIG. 5.

In some cases, the luminance efficiency of the organic EL devices may be dependent upon the environment temperature. In such cases, the temperature may be measured instead of detection of the brightness to feed it back to the organic EL panel in a similar way to that described above.

Exemplary Devices Incorporating Electrooptical Apparatus of the Present Invention

Examples in which the aforementioned organic EL display apparatus is applied to information terminals such as a folding cellular telephone and a PDA are described below. FIG. 8 is a perspective view of a folding cellular telephone 100. The cellular telephone 100 shown in this figure uses a hinge mechanism (hinge unit) 110 to achieve a two-fold device, and the cellular telephone 100 which is not folded but is open is shown.

A brightness sensor 120 is located so as to face an organic EL panel 130, thereby providing a shield structure which prevents light from the outside in the folded state of the phone, and the brightness sensor 120 is positioned at the center of this facing portion. The brightness sensor 120 can also function as a light sensor of a digital camera when it is built therein.

The hinge unit 110 includes a shielded light detection sensor 140 (brightness detectability determination unit) for determining whether or not the cellular telephone is folded, as shown in the side view of FIG. 9, so that the brightness sensor 120 can ensure accurate measurement of light brightness of the organic EL panel 130. As shown in this figure, an example of the shielded light detection sensor 140 is of the leaf spring type that includes a projection 140a at the side of the organic EL panel 130 and a leaf spring 140b at the side of the brightness sensor 120. With this structure, when the cellular telephone 100 is folded for brightness adjustment, abutment of the projection 140a on the leaf spring 140b causes a conduction signal to be output, thus making it possible to determine whether or not light is shielded in the sequence of the above-noted embodiments. An equivalent circuit of the shielded light detection sensor 140 is shown in, for example, FIG. 10.

In order to detect the light shielding state, the above-described shielded light detection unit need not be additionally used, and the light shielding state may be determined when the output of the brightness sensor in the non-display state is not greater than a predetermined threshold value. In this case, there is no need for a shielded light detection sensor in addition, thus reducing the number of parts and achieving a simple structure as a whole.

In the folded but open state of the phone, the brightness sensor may also be used not only for the purpose of brightness compensation for to the degradation over time but also used as an external-light sensor for brightness adjustment of the organic EL panel so as to cancel the influence of the external light.

In the present invention, pixel colors are not limited to three colors, R, G, and B (red, green, and blue), and any other color may be used.

### OTHER APPLICATION EXAMPLES

Some specific examples of the above-described electronic apparatus in which an organic EL display apparatus is used for an electronic device are described below. First, an example in which the organic EL display unit according to this embodiment is applied to a mobile personal computer is described. FIG. 11 is a perspective view showing the structure of the mobile personal computer. In this figure, a personal computer 1100 includes a main body 1104 having a keyboard 1102, and a display unit 1106, and the display unit 1106 includes the above-described organic EL display apparatus.

FIG. 12 is a perspective view showing the structure of a digital still camera whose finder is implemented by the above-described organic EL display apparatus. In this figure, a connection with an external device is also illustrated in a simple manner. While a typical camera creates an optical image of an object to allow a film to be exposed, a digital still camera 1300 photoelectrically converts an optical image of an object using an imaging device such a CCD (Charge Coupled Device) to generate an imaging signal. The above-described organic EL display apparatus is placed on a rear surface of a case 1302 of the digital still camera 1300 to perform display based on the imaging signal generated by the CCD, and the organic EL display apparatus functions as a finder for displaying the object. A light-receiving unit 1304 including an optical lens and the CCD is also placed on the viewing side of the case 1302 (in this figure, the rear surface).

When a photographer views an image of an object displayed on the organic EL display apparatus and presses a shutter button 1306, the imaging signal of the CCD at this time is transferred and stored in a memory on a circuit board 1308. In the digital still camera 1300, a video signal output terminal 1312 and an input/output terminal 1314 for data communication are placed on a side surface of the case 1302. As shown in the figure, a TV monitor 1430 is connected to the former video signal output terminal 1312, and a personal computer 1430 is connected to the latter input/output terminal 1314 for data communication, if necessary. The imaging signal stored in the memory on the circuit board 1308 is output by a,predetermined operation to the TV monitor 1430 or the personal computer 1440.

Examples of electronic devices to which the organic EL display apparatus of the present invention is applicable include, in addition to the personal computer shown in FIG. 11 and the digital still camera shown in FIG. 12, a television set, a viewfinder-type or direct-view monitor type video tape recorder, a car navigation system, a pager, an electronic organizer, an electronic calculator, a word processor, a workstation, a TV phone, a POS terminal, a touch-panel-equipped device, a smart robot, a lighting device having a light control function, and an electronic book. It is to be understood that the above-described organic EL display apparatus can be implemented as a display unit of such electronic devices.

The amount of drive current to be supplied to electrooptical devices is controlled, thus enabling a change in brightness to be compensated for. Specifically, the brightness can be maintained constant, and the degradation of color reproduction of image data can be greatly reduced.

### BRIEF DESCRIPTION OF THE DRAWINGS

FIG. 1 is an illustration of an organic EL display apparatus according to the present invention, in which (a) is a control block diagram of the overall apparatus and (b) is a control block diagram of an organic EL control circuit 30.

FIG. 2 is a flowchart showing a sequence control of brightness correction of the organic EL display apparatus according to the present invention.

FIG. 3 is a flowchart showing a sequence control of brightness correction of the organic EL display apparatus according to the present invention.

FIG. 4 is a characteristic graph of output voltage Eout of a brightness sensor in the organic EL display apparatus according to the present invention with respect to an image data value.

FIG. 5 is a block diagram showing dynamic brightness correction of the organic EL display apparatus according to the present invention.

FIG. 6 is an illustration of an organic EL display apparatus according to the present invention, in which (a) is a control block diagram of the overall apparatus and (b) is a control block diagram of an organic EL control circuit 30.

FIG. 7 is an illustration of an organic EL display apparatus according to the present invention, in which (a) is a control block diagram of the overall apparatus and (b) is a control block diagram of an organic EL control circuit 30.

FIG. 8 is a perspective view of a folding cellular telephone 100 according to an application example of the organic EL display apparatus as an embodiment of the present invention.

FIG. 9 is a side view of the cellular telephone shown in FIG. 8.

FIG. 10 is an equivalent circuit diagram of a shielded light detection sensor 140 in an organic EL display apparatus according to one embodiment of the present invention.

FIG. 11 is a diagram showing an example in which the electrooptical apparatus according to an embodiment of the present invention is applied to a mobile personal computer.

FIG. 12 is a perspective view of a digital still camera whose finder is implemented by an electrooptical apparatus according to an embodiment of the present invention.

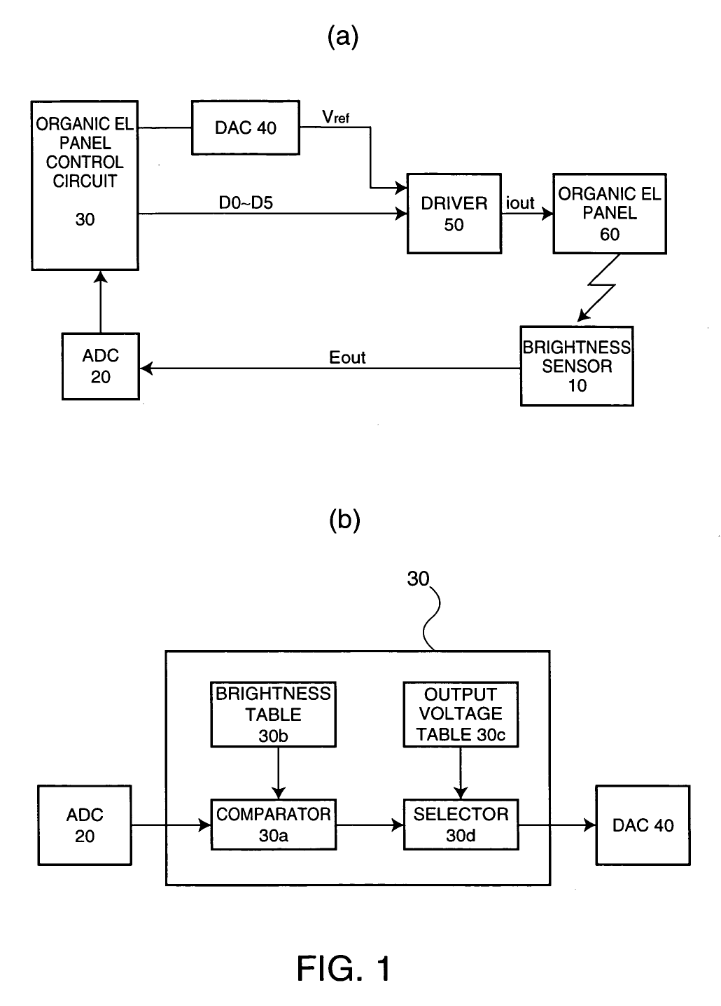

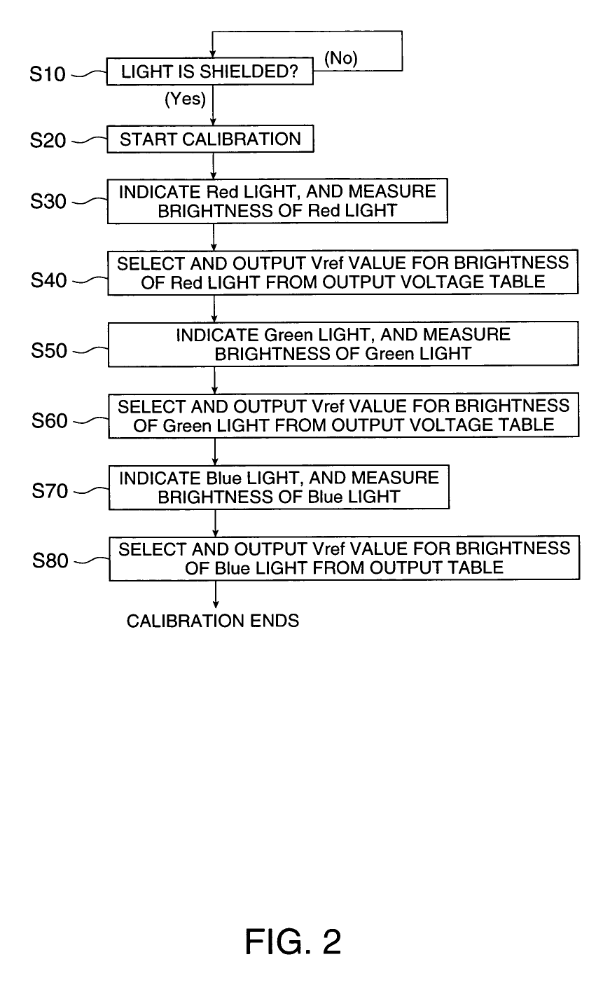

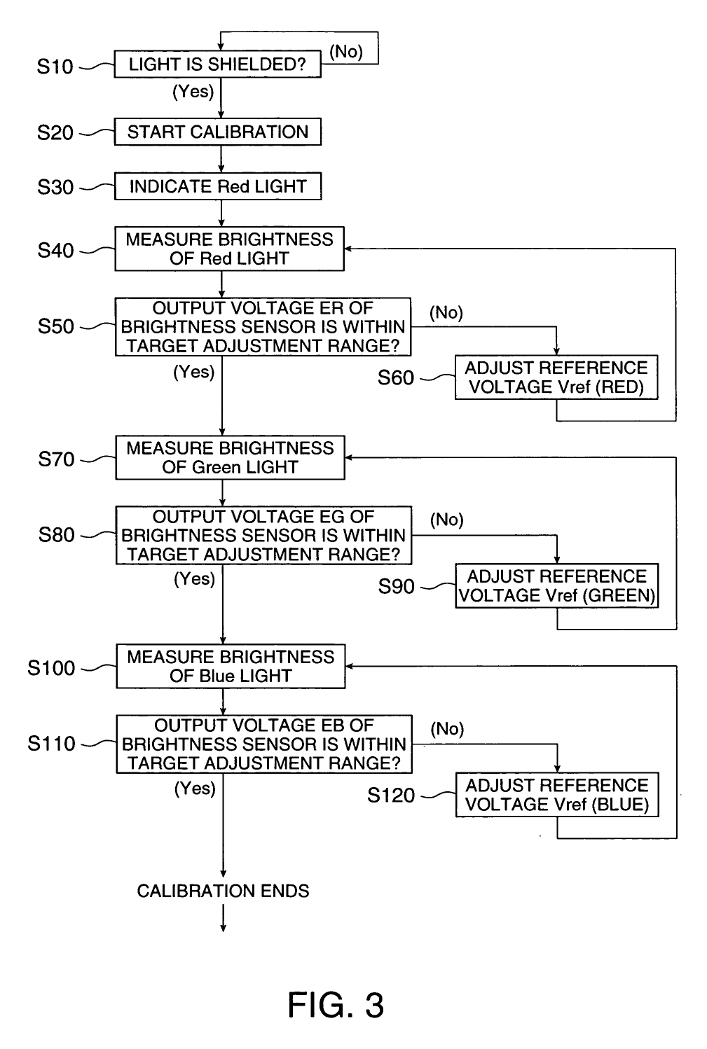

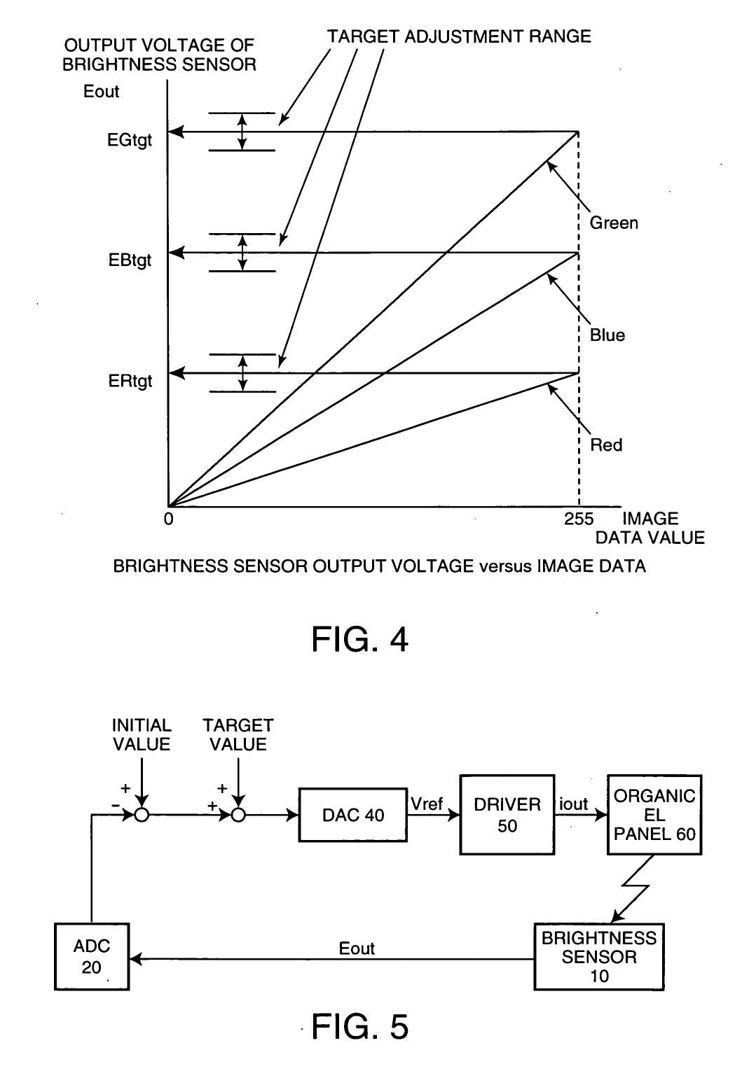

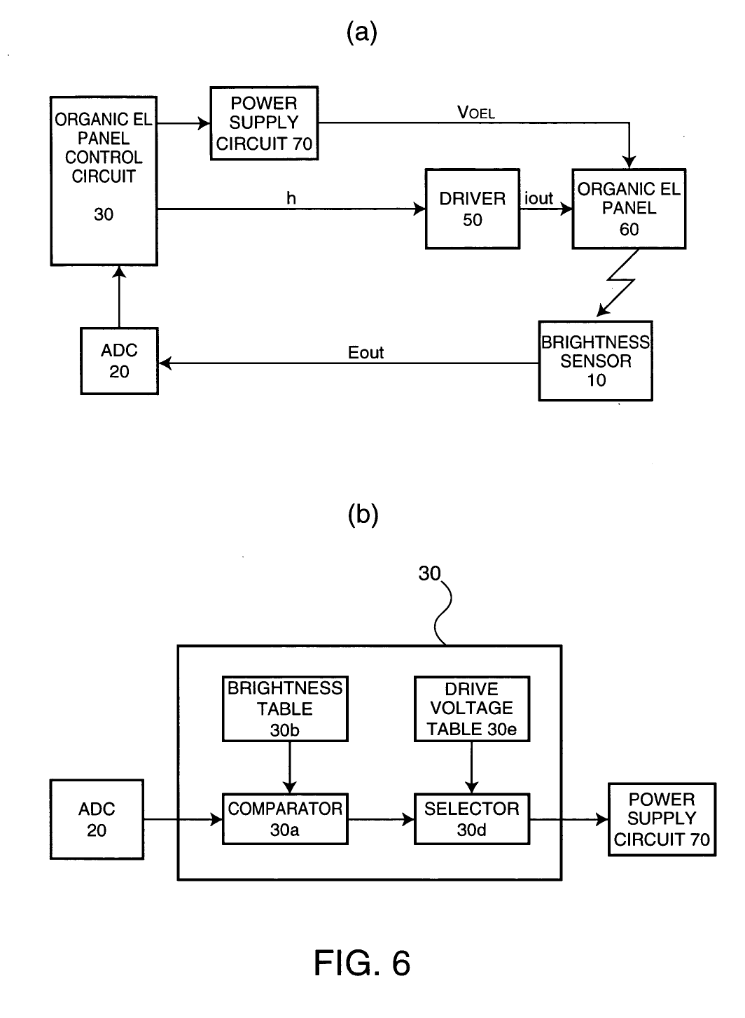

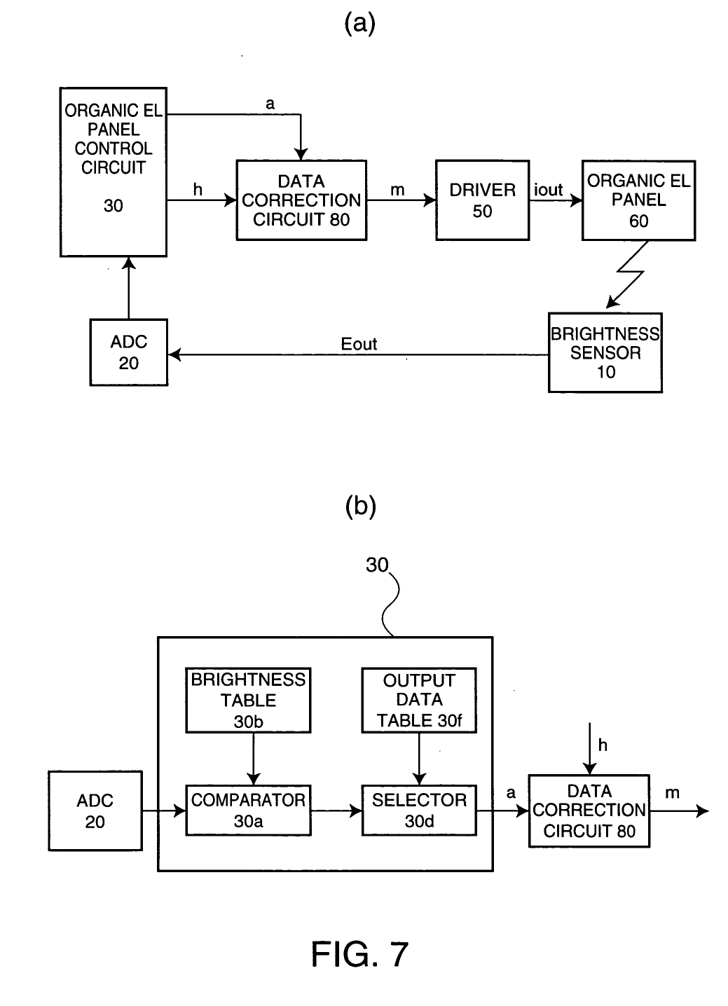

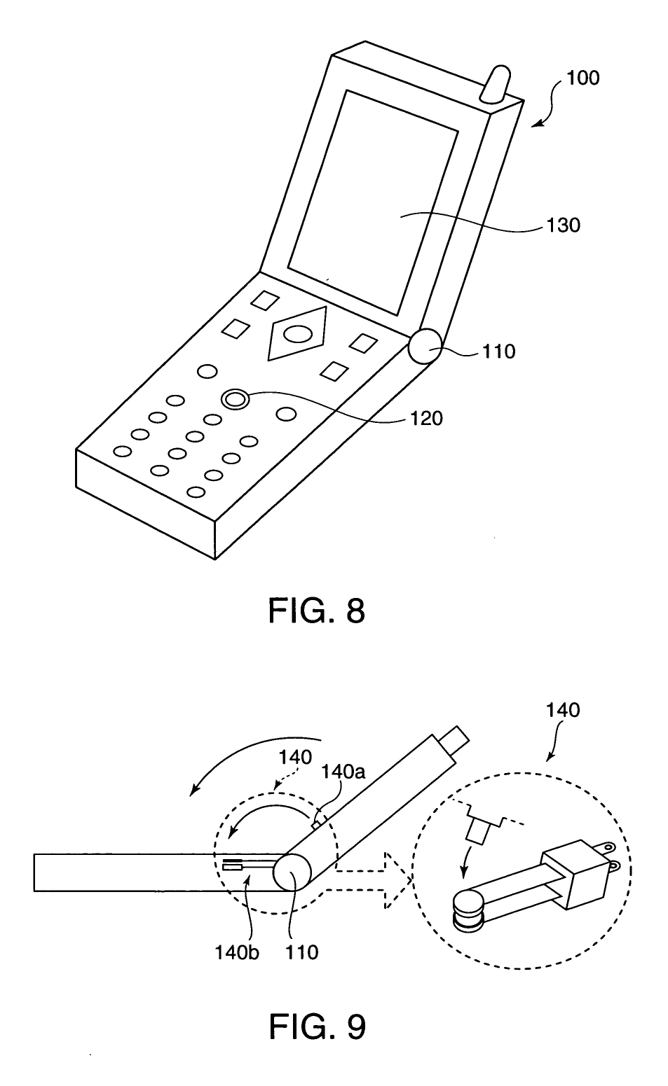

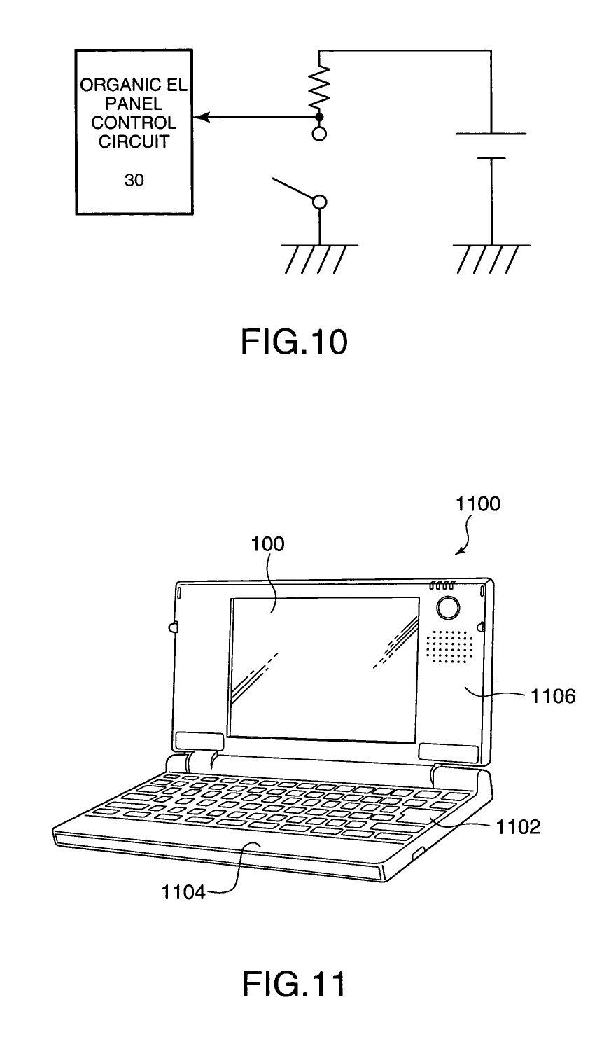

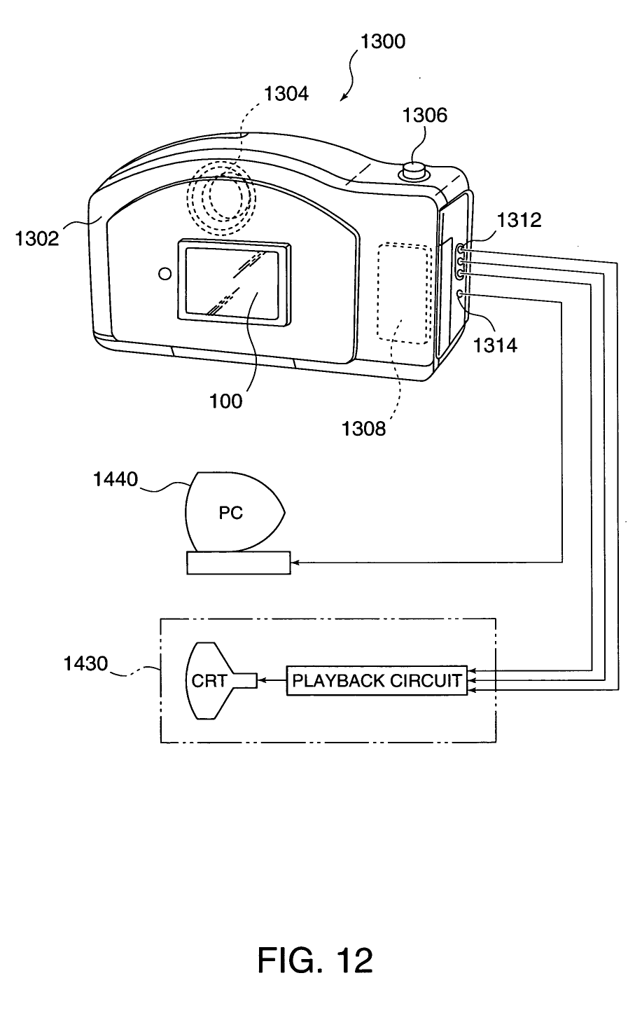

### REFERENCE NUMERALS

10: brightness sensor
20: analog-to-digital converting circuit
30: organic EL panel control circuit
40: digital-to-analog converter
50: driver
60: organic EL panel
30a: comparator 30a
30b: brightness table
30c: output voltage table
30d: selector
100: cellular telephone
110: hinge mechanism (hinge unit)
120: brightness sensor
130: organic EL panel
1100: personal computer
1102: keyboard
1104: main body
1106: display unit
1300: digital still camera
1302: case
1304: light-receiving unit
1306: shutter button
1308: circuit board
1312: video signal output terminal
1314: input/output terminal for data communication
1430: TV monitor
1440: personal computer

1. An electro-optical device, comprising:
a plurality of scanning lines;
a plurality of signal lines;
an electro-optical element placed at an intersection of each of the scanning lines and each of the signal lines, the electro-optical device being driven according to an amount of drive current supplied to the electro-optical elements;
a brightness detection unit to detect a brightness of the electro-optical elements; and
a drive current amount adjusting unit to adjust the amount of drive current based on the detected brightness result obtained by said brightness detection unit.

2. An electro-optical device, comprising:
a plurality of scanning lines;
a plurality of signal lines;
an electro-optical device placed at an intersection of each of the scanning lines and each of the signal lines;
a driver which includes a D/A converter to convert digital data into analog data and which supplies the analog data to the electro-optical devices;
a brightness detection unit to detect a brightness of the electro-optical devices; and
a reference voltage adjusting unit to adjust a reference voltage for the D/A converter based on the detected brightness result obtained by the brightness detection unit.

3. An electro-optical apparatus, comprising:
a plurality of scanning lines;
a plurality of signal lines;
an electro-optical device placed at an intersection of each of the scanning lines and each of the signal lines;
a driver to supply luminance data to the electro-optical devices;
a control circuit to supply to the driver digital data which is a reference for the luminance data;
a brightness detection unit to detect a brightness of the electro-optical devices; and
a data correction circuit to correct the digital data based on the detected brightness result obtained by the brightness detection unit.

4. The electro-optical apparatus according to claim 1, the electro-optical devices including three types of electro-optical devices for R (red), G (green), and B (blue), and
the brightness detection unit detecting the brightness for each of the three types of electro-optical devices.

5. The electro-optical apparatus according to claim 1, the electro-optical devices including three types of electro-optical devices for R (red), G (green), and B (blue);
the three types of electro-optical devices illuminating R (red), G (green), and B (blue) light by passing light emitted from a common light source for the three types of electro-optical devices through a color conversion unit provided for each of the three types of electro-optical devices; and
the brightness detection unit detecting the brightness of the common light source as the brightness of the electro-optical devices.

6. The electro-optical apparatus according to claim 1, the electro-optical devices including three types of electro-optical devices for R (red), G (green), and B (blue);
the three types of electro-optical devices illuminating R (red), G (green), and B (blue) light by passing light emitted from a common light source for the three types of electro-optical devices through a color conversion unit provided for each of the three types of electro-optical devices; and
the brightness detection unit detecting the light passing through at least one of the color conversion units of the three types of electro-optical devices for the brightness of the electro-optical devices.

7. The electro-optical apparatus according to claim 1, further comprising a brightness detectability determination unit to determine whether or not the brightness detection by said brightness detection unit is possible.

8. The electro-optical apparatus according to claim 1, a determination being made as to whether or not the brightness detection by the brightness detection unit is possible based on the brightness of the electro-optical devices detected by the brightness detection unit.

9. An electronic device, comprising:
the electro-optical apparatus according to claim 1.

10. A driving method of an electro-optical apparatus having a plurality of scanning lines, a plurality of signal lines, and an electro-optical device placed at an intersection of each of the scanning lines and each of the signal lines, the driving method comprising:
detecting a brightness of the electro-optical devices; and
adjusting an amount of drive current based on the detected brightness result.

11. A driving method of an electro-optical device having a plurality of scanning lines, a plurality of signal lines, an electro-optical element placed at an intersection of each of the scanning lines and each of the signal lines, and a driver which includes a D/A converter to convert digital data into analog data and which supplies the analog data to the electro-optical elements, the driving method comprising:
detecting a brightness of the electro-optical devices; and
defining a reference voltage for the D/A converter based on the detection result obtained.

12. A driving method of an electro-optical apparatus having a plurality of scanning lines, a plurality of signal lines, and an electro-optical device placed at an intersection of each of the scanning lines and each of the signal lines, brightness data being supplied to the electro-optical devices via a driver, the driving method comprising:
detecting a brightness of the electro-optical devices; and
correcting the digital data based on the detection result obtained.

13. The driving method according to claim 11, the detecting including detecting the brightness for each of three colors, R, G, and B (red, green, and blue).

14. The driving method according to claim 10, further including, prior to the detecting, determining in advance whether or not the brightness detection is possible.

15. The driving method according to claim 10, further including determining whether or not the brightness detection by the brightness detection unit is possible based on the detected brightness of the electro-optical devices.
